(19) United States
(12) Patent Application Publication
(10) Pub. No.: US 2025/0087662 A1
(43) Pub. Date: Mar. 13, 2025

(54) METHOD FOR PRODUCING SECONDARY BATTERY

(71) Applicant: TOYOTA JIDOSHA KABUSHIKI KAISHA, Toyota-shi (JP)

(72) Inventor: Seigo FUJISHIMA, Miyoshi-shi (JP)

(73) Assignee: TOYOTA JIDOSHA KABUSHIKI KAISHA, Toyota-shi (JP)

(21) Appl. No.: 18/825,574

(22) Filed: Sep. 5, 2024

(30) Foreign Application Priority Data
Sep. 12, 2023 (JP) 2023-147660

(51) Int. Cl. H01M 4/04

(52) U.S. Cl. CPC H01M 4/0471

(57) ABSTRACT

To provide a method for producing a secondary battery, which is configured to suppress the occurrence of warpage of a current collector during the welding of the resin member to the current collector. A method for producing a secondary battery comprising a current collector comprising a first metal foil and a second metal foil and a resin member welded to a peripheral portion of the current collector, wherein the method comprises welding the resin member to the current collector that is arranged to be sandwiched by the resin member; wherein the first metal foil has a first linear expansion coefficient; wherein the second metal foil has a second linear expansion coefficient; wherein the first linear expansion coefficient is larger than the second linear expansion coefficient.

### CROSS REFERENCE TO RELATED APPLICATIONS

This application claims priority to Japanese Patent Application No. 2023-147660 filed Sep. 12, 2023, the entire contents of which are incorporated herein by reference.

### TECHNICAL FIELD

The disclosure relates to a method for producing a secondary battery.

### BACKGROUND

Various studies have been proposed for producing the secondary battery as disclosed in Patent Document 1.

Patent Document 1: Japanese Patent Application Laid-Open (JP-A) No. 2023-000059

In the related art, a sealing material (resin member) for sealing the peripheral portion of a current collector is welded by non-contact heating. During the welding of the sealing material to the current collector, the current collector may be warped due to the difference in the linear expansion coefficients of the two types of metal foils constituting the current collector. In particular, when laser welding is performed from the metal foil side having a large linear expansion coefficient, the current collector is directly heated and is remarkably warped, accordingly.

### SUMMARY

The disclosure was achieved in light of the above circumstances. An object of the disclosure is to provide a method for producing a secondary battery, which is configured to suppress the occurrence of warpage of a current collector during the welding of the resin member to the current collector.

That is, the present disclosure includes the following embodiments.

<1>A method for producing a secondary battery comprising a current collector comprising a first metal foil and a second metal foil and a resin member welded to a peripheral portion of the current collector,
wherein the method comprises welding the resin member to the current collector that is arranged to be sandwiched by the resin member;
wherein the first metal foil has a first linear expansion coefficient;
wherein the second metal foil has a second linear expansion coefficient;
wherein the first linear expansion coefficient is larger than the second linear expansion coefficient; and
wherein, in the welding, an amount of heat applied to the first metal foil is smaller than an amount of heat applied to the second metal foil.

By making the amount of heat applied to the first metal foil side having a large linear expansion coefficient, smaller than the second metal foil side, the occurrence of warpage of the current collector at the time of welding the resin member is suppressed.

<2> The method for producing the secondary battery according to <1>,
wherein, in the welding, the resin member is welded to the current collector by a laser, and
wherein the laser is irradiated from the second metal foil side.

By irradiating the laser from the second metal foil side having a relatively small linear expansion coefficient, the occurrence of warpage of the current collector due to a difference in linear expansion coefficient is reduced.

<3> The method for producing the secondary battery according to <1>,
wherein, in the welding, the resin member is welded to the current collector by a laser;
wherein the laser is irradiated from the first metal foil side at a first laser intensity, and it is irradiated from the second metal foil side at a second laser intensity; and
wherein the second laser intensity is larger than the first laser intensity.

When both of the metal foils are directly irradiated with the laser, the intensity of the laser irradiated from the second metal foil side having a relatively small linear expansion coefficient is relatively large, thereby reducing the occurrence of warpage of the current collector, which is due to the difference in the linear expansion coefficient.

<4> The method for producing the secondary battery according to <2>,
wherein the resin member is in contact with a first member on a surface opposite to a surface in contact with the first metal foil on the first metal foil side, and the resin member is in contact with a second member on a surface opposite to a surface in contact with the second metal foil on the second metal foil side, and
wherein a thermal conductivity of the first member is larger than a thermal conductivity of the second member.

When the thermal conductivity of the first member in contact with the first metal foil side having a large linear expansion coefficient is larger than the thermal conductivity of the second member, the amount of linear expansion of the first metal foil is reduced.

In the method for producing the secondary battery of the present disclosure, the occurrence of warpage of the current collector is suppressed during the welding of the resin member to the current collector.

### BRIEF DESCRIPTION OF THE DRAWINGS

In the accompanying drawings,

FIG. 1 is a schematic view showing an example of a welding step of Comparative Example 1;

FIG. 2 is an image of a workpiece after the welding step of Comparative Example 1;

FIG. 3 is an image of a workpiece after the welding step of Example 1;

FIG. 4 is a schematic view showing an example of a welding step of Comparative Example 2;

FIG. 5 is a schematic view showing an example of a welding step of Example 2; and

. FIG. 6 is an image of a workpiece after the welding step of Example 2.

### DETAILED DESCRIPTION

Hereinafter, the embodiments of the present disclosure will be described in detail. Matters that are required to implement the present disclosure (such as common a secondary battery structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

The method for producing a secondary battery of the present disclosure is a method for producing a secondary battery comprising a current collector comprising a first metal foil and a second metal foil and a resin member welded to a peripheral portion of the current collector,
wherein the method comprises welding the resin member to the current collector that is arranged to be sandwiched by the resin member;
wherein the first metal foil has a first linear expansion coefficient;
wherein the second metal foil has a second linear expansion coefficient;
wherein the first linear expansion coefficient is larger than the second linear expansion coefficient; and
wherein, in the welding, an amount of heat applied to the first metal foil is smaller than an amount of heat applied to the second metal foil.

In particular, in the case of using a welding method involving laser welding of a foil and a sealing film resin or heating of an impulse sealer or the like as a method of sealing an outer peripheral resin seal to prevent an electrolyte of a bipolar battery, in order to improve the energy density, the foil needs to be as thin as possible in order to improve the energy density. In addition, since it is necessary to ensure corrosion resistance by forming a cathode or anode potential and a coating, it is difficult to make the foil sandwiched between cathode and anode consist of one type of metal because it is necessary to select a metal which is as low as the reactivity and the electric resistivity is as low as possible for both cathode surface and anode surface throughout the year.

Therefore, in the case of performing the sealing film welding process with the above-described heating, particularly as the size increases and the welding length increases, warpage caused by the difference in the linear expansion coefficient of the dissimilar metal occurs, and it becomes difficult to stack and battery the intended shape.

In the present disclosure, a laser is irradiated from the second metal foil side having a small coefficient of linear expansion, if necessary, a material having a high thermal conductivity is in direct contact with the first metal foil side having a large coefficient of linear expansion, between the two kinds of metal foils, the maximum attainment temperature of the first metal foil side having a large coefficient of linear expansion during the thermal welding process is relatively low, the maximum attainment temperature of the second metal foil side having a small coefficient of linear expansion is relatively high, by causing a heating temperature difference opposite to the coefficient of linear expansion difference between the two kinds of metal foils, by suppressing the difference in the amount of expansion, after cooling, dimensional difference at room temperature is reduced, it is possible to suppress the warpage.

The manufacturing method of the present disclosure includes a welding step.

The welding step is a step of welding the resin member to the current collector arranged so as to be sandwiched by the resin member.

Examples of the method of welding the resin member to the current collector include an impulse method in which the resin member is welded to the metal foil by using heat conduction in the resin member, a laser welding method (laser welding method), and the like. In the laser welding method, attention is paid to the height of the laser transmittance of the resin member to be welded, and the processing energy efficiency is increased by heating the interface where direct bonding is necessary by transmitting the pressurized portion and the resin by using the laser beam and absorbing heat generation at the metal foil portion, and the temperature of the pressurized portion is hardly increased, so that sticking to the pressurized portion can be prevented. Also, it is possible to dissolve the resin members of both sides of the electric collector with laser irradiation of 1 degree by making the metal foil e.g. 100 μm or less thin foil.

Examples of the resin member include various resin materials such as polyethylene (PE, linear expansion coefficient: 100 to 200×10⁻⁶@293K), polypropylene, polystyrene, ABS resin, modified polypropylene, and acrylonitrile styrene resin. The resin member may be a resin film.

The thickness of the resin member is, for example, 100 μm or more and 120 μm or less.

The first metal foil has a first coefficient of linear expansion, the second metal foil has a second coefficient of linear expansion, and the first coefficient of linear expansion is greater than the second coefficient of linear expansion. Examples of the metal that can be used as the metal foil include metals such as aluminum (linear expansion coefficient: 26.4×10⁻⁶@500K, 23.1×10⁻⁶@293K), copper (linear expansion coefficient: 18.3×10⁻⁶@500K, 16.5×10⁻⁶@293K), SUS, and nickel.

For example, aluminum may be selected as the metal of the first metal foil and copper may be selected as the metal of the second metal foil.

The thickness of the metal foil is, for example, 0.1 μm or more and 100 μm or less.

The first metal foil and the second metal foil may be bonded together by an adhesive layer.

The thickness of the adhesive layer is, for example, 0.1 μm or more and 3 μm or less.

The adhesive layer may be a thermoplastic resin.

The resin member side of the first metal foil and the resin member side of the second metal foil may be carbon-coated with a carbon-coated layer.

The thickness of the carbon coating layer is, for example, 0.1 μm or more and 1 μm or less.

In the welding step, the amount of heat applied to the first metal foil is smaller than the amount of heat applied to the second metal foil.

In the welding step, the resin member may be welded to the current collector by a laser.

The laser may be irradiated from the second metal foil side.

By heating the current collector and the resin member formed of two kinds of metal foils in the thickness direction from the second metal foil side having a small linear expansion coefficient in the case of thermal welding the interface between the metal foil and the resin member by a heating means such as a laser, by controlling the expansion amount difference during the heating process, it is possible to suppress the processing failure due to warpage.

The laser may be irradiated from the first metal foil side at a first laser intensity and from the second metal foil side at a second laser intensity. However, the second laser intensity is greater than the first laser intensity.

When heat input from both sides of the current collector is necessary, by reducing the amount of heat input on the first metal foil side having a large linear expansion coefficient, by controlling the expansion amount difference during the heating process, it is possible to suppress the processing failure due to warpage.

The resin member may be in contact with the first member on a surface of the first metal foil side opposite to the surface in contact with the first metal foil, and may be in contact with the second member on a surface of the second metal foil side opposite to the surface in contact with the second metal foil. However, the thermal conductivity of the first member is greater than the thermal conductivity of the second member.

As the first member to the first metal foil having a large linear expansion coefficient, by adhering a metal or the like having a high thermal conductivity, by controlling the expansion amount difference during heating processing, it is possible to suppress the processing failure due to warpage.

The current collector and the resin member may be sandwiched between the first member and the second member and may be pressurized by the first member and the second member.

On the first metal foil side opposite to the second metal foil side (heated surface) to be irradiated with the laser beam, as the first member, the thermal conductivity represented by metal is 15W/(m·K) @100° C. or higher it is desirable to support.

Examples of the first member include aluminum and SUS.

Examples of the second member include SUS, glasses, hard rubber, PE, and silicone rubber.

For reference, the thermal conductivity of glass (quartz glass) is 1.4 W/(m·K) @0° C. and 1.9 W/(m·K) @100° C., aluminum is 236 W/(m·K) @0° C. and 240 W/(m·K) @100° C., SUS is 15 W/(m·K) @0° C. and 16.5 W/(m·K) @100° C., hard rubber is 0.2 W/(m·K) @0° C., and PE is 0.25 to 0.34 W/(m·K) @room temperature.

A secondary battery obtained by the manufacturing method of the present disclosure is obtained by welding a resin member to a peripheral edge portion of a current collector including a first metal foil and a second metal foil.

The current collector comprises a first metal foil and a second metal foil. The current collector is not limited to a bonded foil in which the first metal foil and the second metal foil are bonded, and the two metal foils may be welded by a resin member at an end portion.

The current collector is usually provided with an electrode layer on a current collector in a region other than a region in which a resin member to be welded to a peripheral edge portion of the current collector is present, the region being inside the surface direction of the current collector.

The electrode layer may be a cathode layer or a anode layer.

The current collector may be a anode current collector, a cathode current collector, a bipolar current collector, or the like.

In the secondary battery obtained by the manufacturing method of the present disclosure, a plurality of current collectors may be stacked in the stacking direction.

The number of stacked current collectors is not particularly limited, and may be 2 to several hundred.

The secondary batteries may include a anode current collector, a anode layer, an electrolyte layer, a cathode layer, and a cathode current collector.

The type of the secondary battery of the present disclosure is not particularly limited, and examples thereof include a nickel-hydrogen secondary battery and a lithium-ion secondary battery. The secondary battery may be a liquid-based secondary battery using an electrolyte solution as an electrolyte, or a solid secondary battery using a solid electrolyte as an electrolyte. Examples of applications of the secondary batteries include power sources for vehicles such as hybrid electric vehicles (HEV), plug-in hybrid electric vehicles (PHEV), battery electric vehicles (BEV), gasoline-powered vehicles, and diesel-powered vehicles. Among them, it may be used as a power source for driving a hybrid electric vehicle (HEV), a plug-in hybrid electric vehicle (PHEV), or a battery electric vehicle (BEV). Further, the secondary battery may be used as a power source for a moving object (for example, a railway, a ship, or an aircraft) other than the vehicle, or may be used as a power source for an electric product such as an information processing apparatus.

### EXAMPLES

### Comparative Example 1

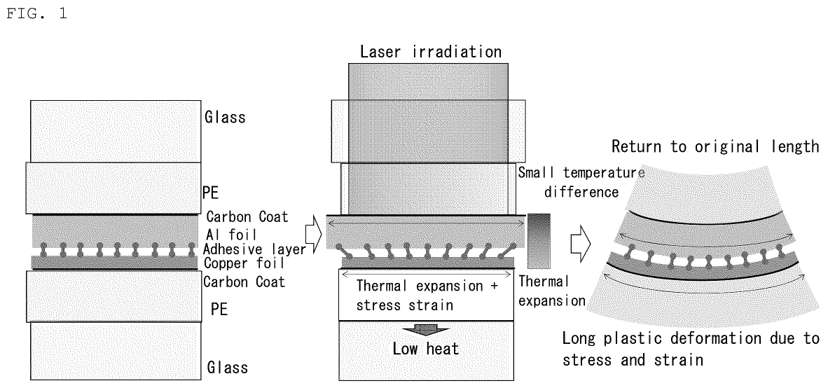

FIG. 1 is a schematic view showing an example of a welding step of Comparative Example 1.

As shown in FIG. 1, as a second member, glass, a PE (120 μm) as a resin member, a carbon coating layer (<1 μm), an aluminum foil (40 μm) as a second metal foil, an adhesive layer (3 μm), a copper foil (7.8 μm) as a first metal foil, a carbon coating layer (<1 μm), a PE (120 μm) as a resin member, a work using glass as a first member was prepared.

Laser irradiation was performed from the second metal foil (aluminum foil) side, and the resin member was welded to the peripheral edge portion of the current collector including the first metal foil and the second metal foil.

In Comparative Example 1, the first linear expansion coefficient (18.3×10⁻⁶@500K) of the first metal foil (copper foil) is smaller than the second linear expansion coefficient (26.4×10⁻⁶@500K) of the second metal foil (aluminum foil).

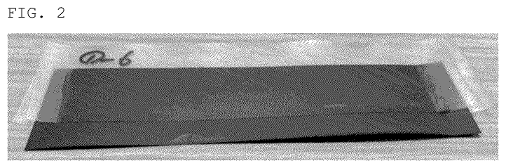

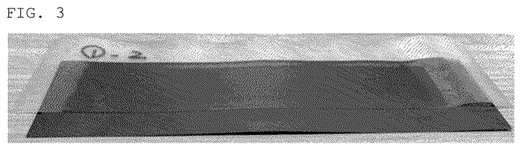

The results are shown in FIG. 2, Table 1.

FIG. 2 is an image of a workpiece after the welding step of Comparative Example 1.

As shown in FIG. 2, warpage occurs in the workpiece after the welding process of Comparative Example 1.

During the heat welding, the expansion amount of aluminum is larger than that of copper due to the difference in the linear expansion coefficient. As a result, stress in the elongation direction is generated on the thin copper side fixed by the adhesive layer, stress strain in the plastic region is generated.

It is presumed that the warpage occurs because the long line length difference occurs in the copper side when it returns to the normal temperature. Since PE is softened, it is presumed that it slides at the interface, and the interface is fixed in the process of lowering the temperature, so that it is not involved in the warping.

### Example 1

Except for preparing a workpiece using aluminum foil (40 μm) as the first metal foil and copper foil (7.8 μm) as the second metal foil, a laser was irradiated from the second metal foil (copper foil) side in the same manner as in Comparative Example 1, and a resin member was welded to the peripheral portion of the current collector.

In Example 1, the first linear expansion coefficient (26.4×10⁻⁶@500K) of the first metal foil (aluminum foil) is greater than the second linear expansion coefficient (18.3×10⁻⁶@500K) of the second metal foil (copper foil).

FIG. 3 is an image of a workpiece after the welding step of Example 1.

As shown in FIG. 3, warpage of the workpiece after the welding process of Example 1 is suppressed.

When the laser irradiation side is the second metal foil (copper foil) side having a low linear expansion coefficient, the arrival temperature of the second metal foil (copper foil) side having a low linear expansion coefficient on the laser irradiation side is higher than the first metal foil (aluminum foil) side having a high linear expansion coefficient on the anti-laser irradiation side, the expansion amount difference between aluminum and copper is relaxed, the stress strain in the plastic region on the second metal foil (copper foil) side, the line length difference is reduced, and the warpage is improved.

### Comparative Example 2

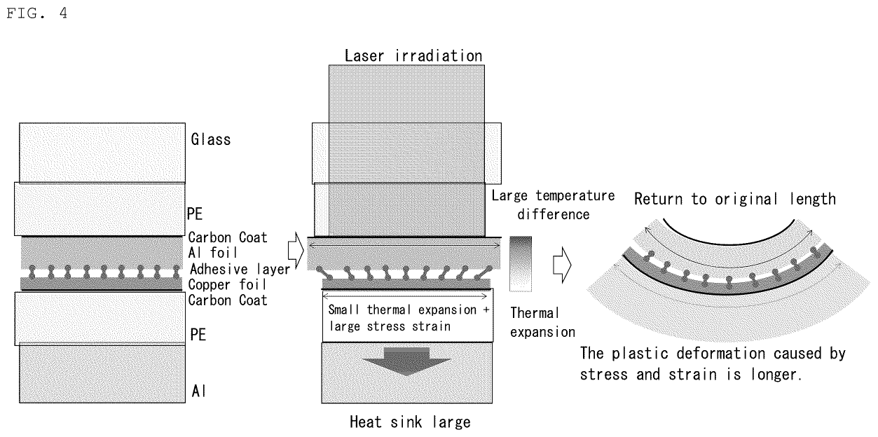

FIG. 4 is a schematic view showing an example of a welding step of Comparative Example 2.

As shown in FIG. 4, the resin member was welded to the peripheral portion of the current collector in the same manner as in Comparative Example 1 except that a workpiece using aluminum was prepared as the first member.

In Comparative Example 2, the first linear expansion coefficient (18.3×10⁻⁶@500K) of the first metal foil (copper foil) is smaller than the second linear expansion coefficient (26.4×10⁻⁶@500K) of the second metal foil (aluminum foil), and the thermal conductivity of the first member (aluminum) is larger than the thermal conductivity of the second member (glass).

When the first member on the receiving side is made of aluminum having high thermal conductivity from glass having low thermal conductivity, the arrival temperature difference between the second metal foil (aluminum foil) side having a high coefficient of linear expansion on the laser irradiation side and the first metal foil (copper foil) side having a low coefficient of linear expansion on the anti-laser irradiation side is further increased, as a result, the expansion amount difference between aluminum and copper is increased, the stress strain in the plastic region on the copper side, the line length difference is also increased, the warping situation is deteriorated compared with Comparative Example 1.

### Example 2

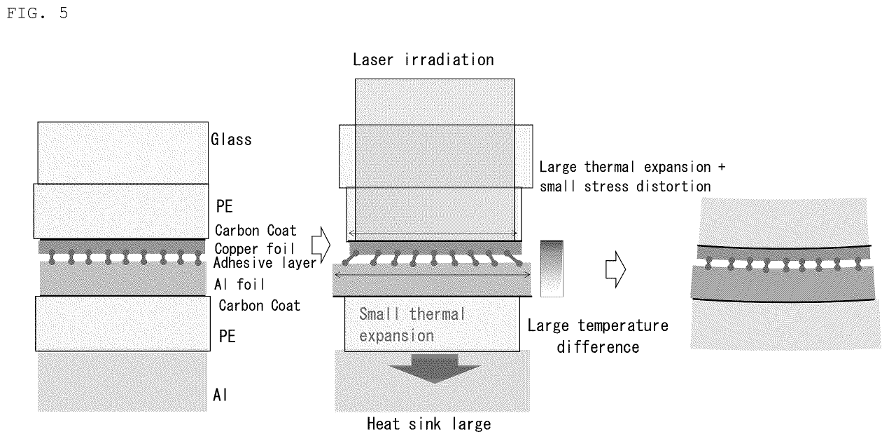

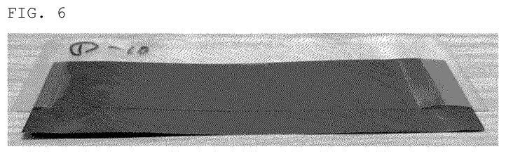

FIG. 5 is a schematic view showing an example of a welding step of Example 2.

As shown in FIG. 5, except that a workpiece was prepared using aluminum foil (40 μm) as the first metal foil, copper foil (7.8 μm) as the second metal foil, and aluminum as the first member, a laser was irradiated from the second metal foil (copper foil) side in the same manner as in Comparative Example 1, and a resin member was welded to the peripheral portion of the current collector.

In Example 2, the first linear expansion coefficient (26.4×10⁻⁶@500K) of the first metal foil (aluminum foil) is greater than the second linear expansion coefficient (18.3×10⁻⁶ @500K) of the second metal foil (copper foil), and the thermal conductivity of the first member (aluminum) is greater than the thermal conductivity of the second member (glass).

FIG. 6 is an image of a workpiece after the welding step of Example 2.

As shown in FIG. 6, warpage of the workpiece after the welding process of the second embodiment is suppressed.

The laser irradiation side is a second metal foil (copper foil) side whose linear expansion coefficient is low, further by the first member on the receiving side is made of aluminum having good thermal conductivity, the arrival temperature of the second metal foil (copper foil) side whose linear expansion coefficient on the laser irradiation side is low is higher than the first metal foil (aluminum foil) side whose linear expansion coefficient on the anti-laser irradiation side is high, by relaxing the expansion amount difference between aluminum and copper, stress strain in the plastic region on the second metal foil (copper foil) side, the line length difference becomes small, warping is further improved as compared with Example 1.

(Examples 3 to 6, Comparative Examples 3 to 6) Except for the conditions shown in Table 1, laser irradiation from the second metal foil side in the same manner as in Comparative Example 1, the resin member was welded to the peripheral portion of the current collector.

TABLE 1

| | | | | | First linear | | |
|---|---|---|---|---|---|---|---|
| | | | | | expansion | Heat | |
| | | | | | coefficient > | conducting | |
| | | First | Second | | Second | (First member > | |
| | First | metal | metal | Second | coefficient of | Second | |
| | member | foil | foil | member | linear expansion | member) | Warp |
| Comparative | Glass | Cu foil | Al foil | Glass | Negative | — | Presence |
| Example 1 | | | | | | | |
| Example 1 | Glass | Al foil | Cu foil | Glass | Positive | — | None |
| Comparative | Al | Cu foil | Al foil | Glass | Negative | Positive | Presence |
| Example 2 | | | | | | | |
| Example 2 | Al | Al foil | Cu foil | Glass | Positive | Positive | None |
| Comparative | Si | Cu foil | Al foil | Glass | Negative | Positive | Presence |
| Example 3 | rubber/ | | | | | | |
| | Al | | | | | | |
| Comparative | Si | Cu foil | Al foil | Glass | Negative | Positive | Presence |
| Example 4 | rubber/ | | | | | | |
| | Al | | | | | | |
| Comparative | SUS | Cu foil | Al foil | Glass | Negative | Positive | Presence |
| Example 5 | | | | | | | |
| Comparative | SUS | Cu foil | Al foil | Glass | Negative | Positive | Presence |
| Example 6 | | | | | | | |
| Example 3 | Si | Al foil | Cu foil | Glass | Positive | Positive | None |
| | rubber/ | | | | | | |
| | Al | | | | | | |
| Example 4 | Si | Al foil | Cu foil | Glass | Positive | Positive | None |
| | rubber/ | | | | | | |
| | Al | | | | | | |
| Example 5 | SUS | Al foil | Cu foil | Glass | Positive | Positive | None |
| Example 6 | SUS | Al foil | Cu foil | Glass | Positive | Positive | None |

In Examples 3 to 6, the laser irradiation side was a second metal foil (copper foil) side having a low linear expansion coefficient, the expansion amount difference between aluminum and copper was relaxed, the stress strain in the plastic region on the second metal foil (copper foil) side, the line length difference was reduced, and warping was suppressed.

On the other hand, in Comparative Examples 3 to 6, the laser irradiation side was the second metal foil (aluminum foil) side having a high coefficient of linear expansion, and the difference in the amount of expansion from the first metal foil (copper foil) side having a low coefficient of linear expansion on the opposite laser irradiation side was increased, resulting in warpage.

Further, as shown in Comparative Examples 2 to 6, in the welding step, when the amount of heat applied to the first metal foil is larger than the amount of heat applied to the second metal foil, even if the thermal conductivity of the first member is larger than the thermal conductivity of the second member, it can be seen that warpage occurs.

1. A method for producing a secondary battery comprising a current collector comprising a first metal foil and a second metal foil and a resin member welded to a peripheral portion of the current collector,
wherein the method comprises welding the resin member to the current collector that is arranged to be sandwiched by the resin member;
wherein the first metal foil has a first linear expansion coefficient;
wherein the second metal foil has a second linear expansion coefficient;
wherein the first linear expansion coefficient is larger than the second linear expansion coefficient; and
wherein, in the welding, an amount of heat applied to the first metal foil is smaller than an amount of heat applied to the second metal foil.

2. The method for producing the secondary battery according to claim 1,
wherein, in the welding, the resin member is welded to the current collector by a laser, and
wherein the laser is irradiated from the second metal foil side.

3. The method for producing the secondary battery according to claim 1,
wherein, in the welding, the resin member is welded to the current collector by a laser;
wherein the laser is irradiated from the first metal foil side at a first laser intensity, and it is irradiated from the second metal foil side at a second laser intensity; and
wherein the second laser intensity is larger than the first laser intensity.

4. The method for producing the secondary battery according to claim 2,
wherein the resin member is in contact with a first member on a surface opposite to a surface in contact with the first metal foil on the first metal foil side, and the resin member is in contact with a second member on a surface opposite to a surface in contact with the second metal foil on the second metal foil side, and
wherein a thermal conductivity of the first member is larger than a thermal conductivity of the second member.
